(19) United States
(12) Patent Application Publication
(10) Pub. No.: US 2026/0100145 A1
(43) Pub. Date: Apr. 9, 2026

(54) CARD ASSEMBLIES AND METHODS FOR LEARNING AND/OR TEACHING LANGUAGES

(71) Applicant: Jean M. Albert, Bellingham, WA (US)

(72) Inventor: Jean M. Albert, Bellingham, WA (US)

(21) Appl. No.: 18/906,056

(22) Filed: Oct. 3, 2024

(51) Int. Cl. G09B 19/08

(52) U.S. Cl. CPC G09B 19/08

(57) ABSTRACT

A language adapter for modifying a root word classified by a type and a grammatical category to a selected form defined by a language, the language adapter comprising a stem defined by the root word, a card assembly, and a case system. The card assembly comprises a plurality of cards and a connection assembly that rotatably connects the plurality of cards. The case system comprises a plurality of declensions, a plurality of cases, and at least one number group to arrange a plurality of indicia elements. The card assembly is configured to display the case system. The card assembly can be manipulated to isolate and align a selected indicia element with the stem to modify the root word.

### TECHNICAL FIELD

The present invention generally relates to card assemblies and methods for teaching and/or learning a language, more specifically, to systems and methods for teaching and/or learning a language by modifying root words.

### BACKGROUND

Languages such as Latin, Greek, German, or Russian have different inflection forms for nouns, adjectives, verbs, or articles based on their grammatical function in a sentence. The languages utilize case systems to organize the varying inflection forms. These languages require a correct inflection form based on the case, or function, of a word in a sentence. However, the case systems are often complex, and various parameters such as grammatical category, number, or use, are used to identify the correct inflection form.

The case systems typically require large charts, graphs, or other detailed visual representations to designate the differences between each inflection form. These visual representations are often difficult to handle and cannot be easily referenced if the inflection form was not correctly identified.

Thus, the need exists for an assembly that can quickly and efficiently navigate through the complex case systems in order to identify the correct inflection form based on the words type, category, and function in a sentence.

### SUMMARY

The present invention can be embodied as a language adapter for modifying a root word classified by a type and a grammatical category to a selected form defined by a base language. The language adapter comprises a stem, a card assembly, a plurality of sets of indicia elements, and a selected indicia element. The stem is defined by the root word. The card assembly comprises a plurality of cards configured to display text and a connection assembly. The plurality of cards define at least one card surface, at least one group portion further defining at least one array wherein the array is comprised of at least one column and the at least one column is comprised of a plurality of rows. The connection assembly configured to rotatably connect the plurality of cards. Each set of indicia is defined by a case system associated with the base language. The plurality of sets of indicia elements comprises a first set of indicia elements defined by a first list type, a second set of indicia elements defined by a second list type, a third set of indicia elements defined by a third list type, where the third set of indicia elements defines a list order. The selected indicia element is chosen from the plurality of sets of indicia elements determined based on the root word, the first list type, the second list type, and the third list type. The card assembly is configured to display the plurality of sets of indicia elements such that the first set of indicia elements is displayed on the at least one card surface, the second set of indicia elements is displayed in the at least one group portion, and the third set of indicia elements are arranged in the array in the list order such that each row depicts an indicia element. The card assembly can be manipulated so the card displaying the selected indicia element can be aligned with the stem to modify the root word.

The present invention can be embodied as a language adapter for modifying a root word classified by a type and a grammatical category to a selected form defined by a base language. The language adapter comprises a stem, a card assembly, a plurality of sets of indicia elements, and a selected indicia element. The stem is defined by the root word and displayed on a background object. The card assembly comprises a plurality of cards configured to display text and a connection assembly. The plurality of cards define at least one card surface, at least one group portion further defining at least one array wherein the array is comprised of at least one column and the at least one column is comprised of a plurality of rows. The connection assembly configured to rotatably connect the plurality of cards. Each set of indicia is defined by a case system associated with the base language. The plurality of sets of indicia elements comprises a first set of indicia elements defined by a first list type, a second set of indicia elements defined by a second list type, a third set of indicia elements defined by a third list type, where the third set of indicia elements defines a list order. The selected indicia element is chosen from the plurality of sets of indicia elements determined based on the root word, the first list type, the second list type, and the third list type. The card assembly is configured to display the plurality of sets of indicia elements such that the first set of indicia elements is displayed on the at least one card surface, the second set of indicia elements is displayed in the at least one group portion, and the third set of indicia elements are arranged in the array in the list order such that each row depicts an indicia element. The card assembly can be manipulated so the card displaying the selected indicia element can be aligned with the stem on the background object to modify the root word to the selected form.

The present invention can be embodied as a method for modifying a root word with a specific type and grammatical category to a selected form. A stem is determined from the root word. A plurality of cards configured to display text is provided, where each card defining at least one card surface at least one group portion further defining at least one array wherein the array is comprised of at least one column and a plurality of rows. The plurality of cars is rotatably connected with a connection assembly. A plurality of sets of indicia elements defined by a case system associated with the language is provided, comprising a first set of indicia elements defined by a first list type, a second set of indicia elements defined by a second list type, a third set of indicia elements defined by a third list type, where the third set of indicia elements defines a list order. A selected indicia element is chosen from the plurality of sets of indicia elements determined based on the root word, the selected form, the first list type, the second list type, and the third list type. The plurality of sets of indicia elements is displayed on the plurality of cards so that the first set of indicia elements is displayed on the at least one card surface, the second set of indicia elements is displayed in the at least one group portion, the third set of indicia elements are arranged in the array in the list order such that each row depicts an indicia element. The selected indicia element is aligned with the stem to modify the root word to the selected form.

### BRIEF DESCRIPTION OF THE DRAWINGS

FIG. 1A is a front elevation view of a first side of the first example language adapter of the present invention embodied as a first example card assembly displaying a plurality of sets of indicia elements;

FIG. 1B is rear elevation view of a second side of the first example language adapter of the present invention embodied as a first example card assembly displaying the plurality of sets of indicia elements;

FIG. 2 is an elevation view of a definition card of the first example card assembly;

FIG. 3 is an elevation view of the first declension displayed on a card of the first example card assembly;

FIG. 4 is a perspective view of the second declension displayed on a card of the first example card assembly;

FIG. 5 is a perspective view of the second declension displayed on a card of the first example card assembly;

FIG. 6 is a perspective view of the third declension displayed on a card of the first example card assembly;

FIG. 7 is a perspective view of the third declension displayed on a card of the first example card assembly;

FIG. 8 is a perspective view of the fourth declension displayed on a card of the first example card assembly;

FIG. 9 is a perspective view of the fifth declension displayed on a card of the first example card assembly;

FIG. 10 is a perspective view of the first three cards of the first example card assembly;

FIG. 11A is a perspective view of a first indicia element of the first declension as depicted on the first example card assembly and aligned with the stem of a root word on a background object;

FIG. 11B is a perspective view of a second indicia element from the first declension as depicted on the first example card assembly and aligned with the stem of a root word on a background object;

FIG. 12 is a perspective view of an indicia element of the second declension as depicted on the first example card assembly and aligned with the stem of a root word on a background object;

FIG. 13A is a front elevation view of a first side of the first example language adapter of the present invention embodied as a first example card assembly displaying a plurality of sets of indicia elements for root words that are verbs;

FIG. 13B is a rear elevation view of a second side of the first example language adapter of the present invention embodied as a first example card assembly displaying the plurality of sets of indicia elements for root words that are verbs;

FIG. 14A is a front elevation view of a first side of a second example language adapter of the present invention embodied as a second example card assembly displaying a second example plurality of sets of indicia elements;

FIG. 14B is a rear elevation view of a second side of a second example language adapter of the present invention embodied as a second example card assembly displaying the second example plurality of sets of indicia elements;

FIG. 15A is a front elevation view of a first side of a third example language adapter of the present invention embodied as a third example card assembly displaying a third example plurality of sets of indicia elements;

FIG. 15B is a rear elevation view of a second side of a third example language adapter of the present invention embodied as a third example card assembly displaying a third example plurality of sets of indicia elements;

### DETAILED DESCRIPTION

### I. First Example Language Adapter

The language adapter 20 is a system and method for modifying words based on a grammatical case to teach and/or learn different languages using cards displaying text. In languages such as Latin or Greek, nouns, pronouns, adjectives, and verbs will have a different inflection based on their grammatical function in a sentence. These languages utilize case systems to organize the varying inflections into groups such as declensions, which are groupings of inflection forms. Within each declension, the inflection forms can be organized depending on their plurality and case, or function, in a sentence. When given a root word and its grammatical case, the case system defines how the proper inflection form of the root word can be identified.

While the following explanations includes various descriptions and rules associated with the Latin language, the descriptions include only as much information to describe the function of the present invention and are intended to describe the construction and operation of using a card assembly and case system associated with a base language to adapt words based on the grammatical parameters associated with root word types and categories and the root word functions and usage in a sentence or given context.

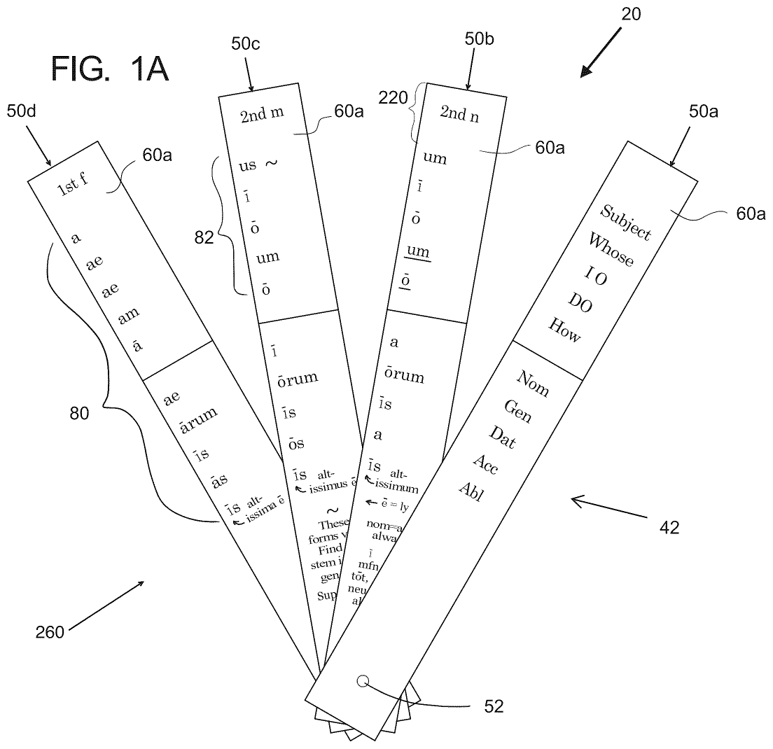

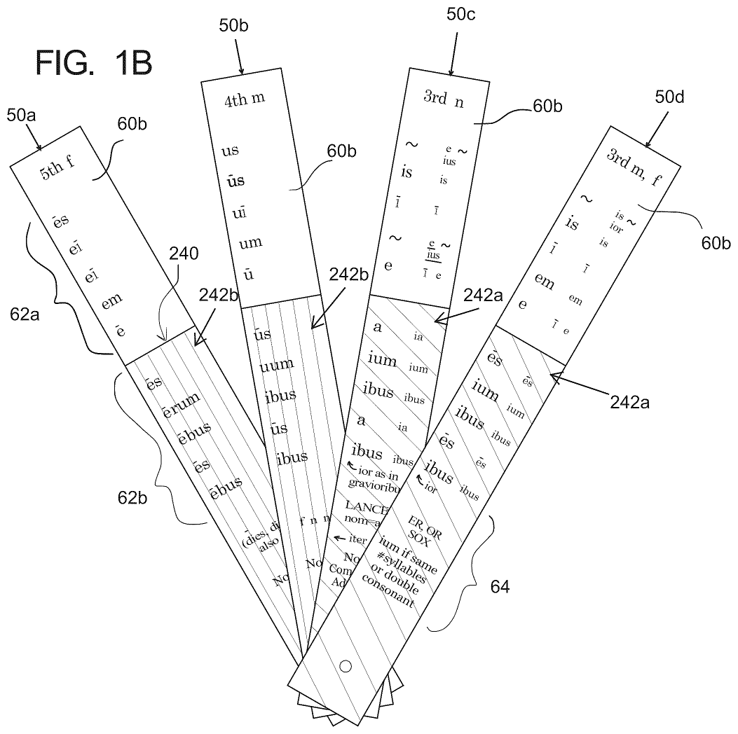

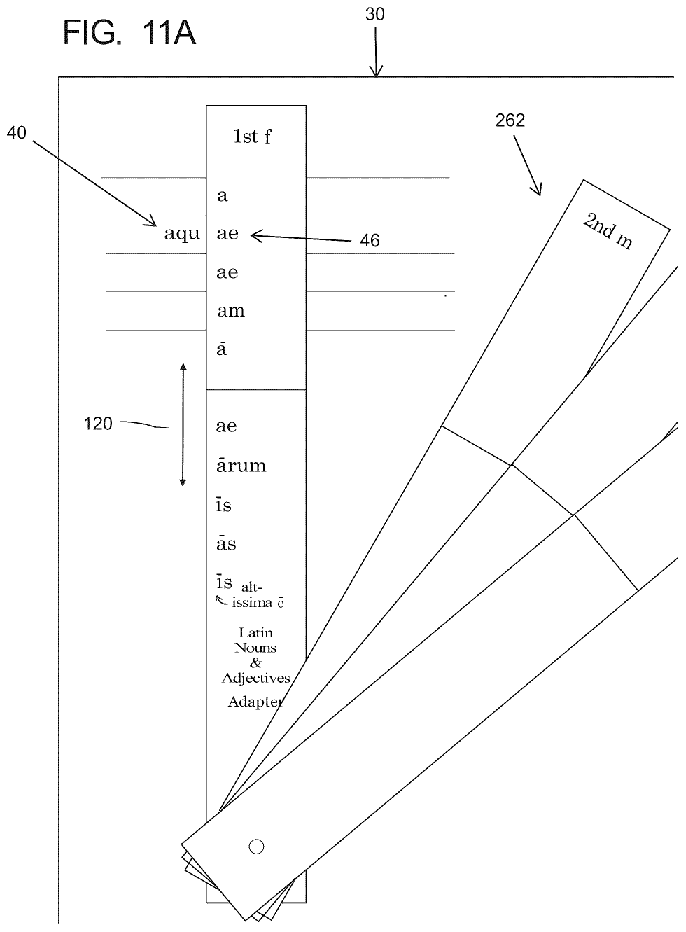

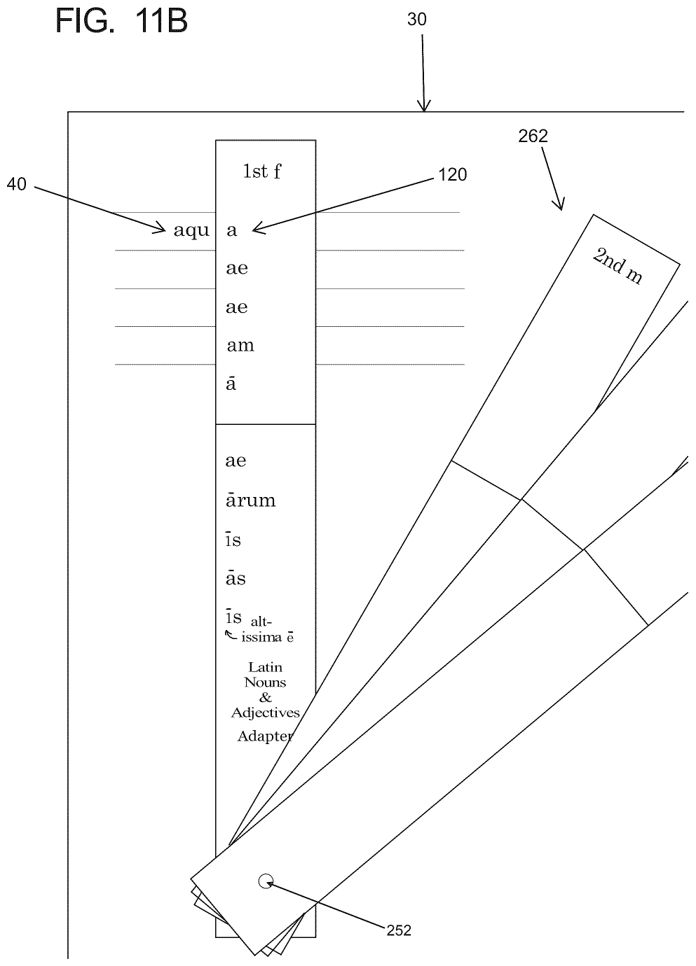

FIG. 1 is a perspective view of the language adapter 20 constructed in accordance with, and embodying, the principles of the present invention. As shown for example in FIGS. 11A and 11B, language adapter 20 can be used to indicate the correct modification for a root word 22 that is classified by a type 24 and grammatical category 26 to a selected form 28 where the selected form 28 is defined by a base language. As further shown in FIGS. 11A and 11B, root word 22 can be depicted on a background object 30, such as a textbook, sheet of paper, or computer screen.

The type 24 of the root word 22, also referred to as the gender of the root word 22, is defined based on the rules of the base language, and classifies words as either feminine, masculine, or neuter. The root word 22 will also be of a certain grammatical category 26 defined by general language rules and can be classified as a noun, pronoun, adjective, or verb.

The selected form 28 is defined by the base language and determined based on the desired use of the root word 22 or based on the context a sentence in which the root word 22 is used. The selected form 28 can be defined as a set of grammatical parameters that indicates what form the root word 22 should take depending on whether the root word 22 is singular or plural and the root words 22 function in a sentence. The selected form 28 can vary as the context or desired use shifts, thus the system and method of use of the language adapter 20 remains consistent even while the selected form 28 varies.

While the language adapter 20 can be used if given a root word 22 in a sentence and the selected declension and indicia element can be determined through the sentence context, the language adapter 20 is also configured to be used given a specific task such as in a grammar practice textbook.

The first example language adapter 20 is comprised of a stem 40, a card assembly 42, a plurality of sets of indicia elements 44, and a selected indicia element 46.

The stem 40 is defined by the root word 22 and is or can be determined by removing the inflectional ending of the root word 22. Thus, the stem 40 is or can be the entire or at least a portion of the root word 22 without an inflectional ending. The stem 40 is chosen based on parameters defined by the base language, for example, the root word “servus” has a stem “serv-.” The stem 40 can also be depicted on a background object 30.

The first example card assembly 42 is configured to display the plurality of sets of indicia elements 44. The first example card assembly 42 is comprised of a plurality of cards 50 and a connection assembly 52. Each card 50 defines a card surface 60 and a group portion 62. Each card 50 can also include a rule portion 64. The group portion 62 further defines an array 70. The example array 70 is comprised of at least one column 72 and a plurality of rows 74.

The plurality of sets of indicia elements 44 is comprised of a first set of indicia elements 80, a second set of indicia elements 82, and a third set of indicia elements 84 defining a list order 86. The plurality of sets of indica elements 44 can also include a rule 88. The first set of indicia elements 80 is defined by a first list type 90. The second set of indicia elements 82 is defined by a second list type 92. The third set of indicia elements 84 is defined by a third list type 94.

The selected indicia element 46 is chosen from the plurality of sets of indicia elements 44 based on the root word 22, the selected form 28, the first list type 90, the second list type 92, and the third list type 94.

The card assembly 42 is configured to display the plurality of sets of indicia elements 44 such that the first set of indicia elements 80 is displayed on each card surface 60, the second set of indicia elements 82 is displayed in the group portion 62, and the third set of indicia elements 84 are arranged according to the list order 86 and displayed in the array 70 such that each row 74 depicts one indicia element from the third set of indicia elements 84.

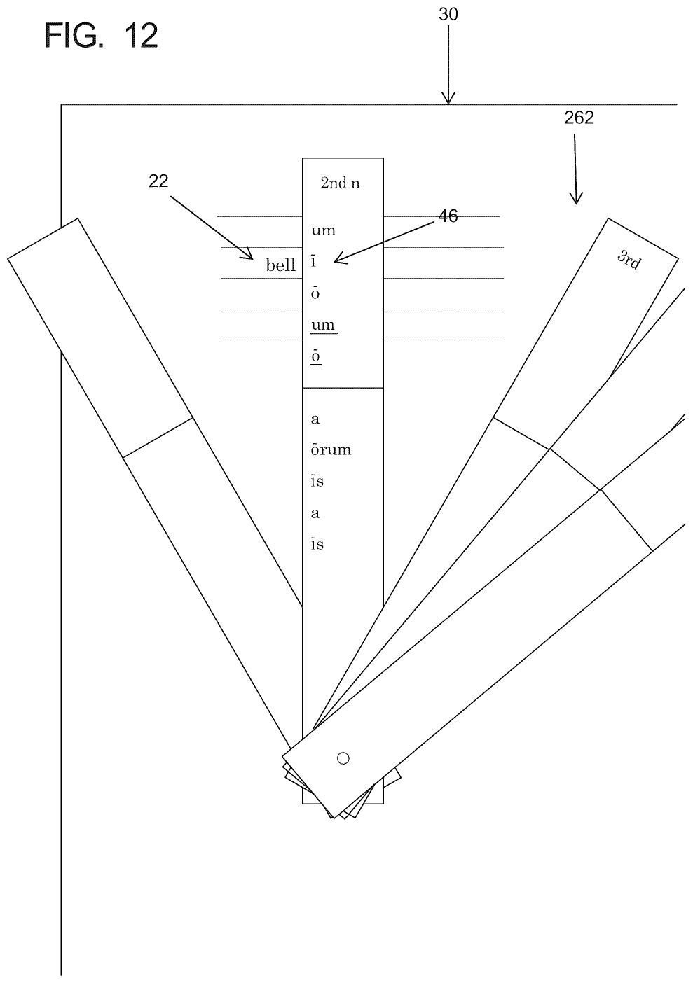

As illustrated in FIGS. 11a, 11b, and 12, the card assembly 42 is configured to be manipulated so the card displaying the selected indicia element 46 can be aligned with the stem 40 to modify the root word 22. If a second selected indicia element 120 is identified, then the second selected indicia element 120 can be aligned with the stem 40 by sliding the card assembly 44, shown by directional arrow 130.

With the foregoing understanding of the structure and use of the present invention in mind, the details of the first example learning adapter 20 will now be
described in further detail. In the following discussion of the first example language adapter 20, the base language is Latin.

In the following discussion, reference characters without suffixes generically refer to an element and reference characters with suffixes refer to specific instances of the same generic element.

The stem 40 is defined by the root word 22. The stem 40 of the root word 22 is the portion of the root word 22 that does not change when the inflection form changes. The stem 40 is typically determined by removing the end of the root word 22; however, various language rules may define how the stem 40 is determined from the root word 22.

As an example, one method of identifying the stem 40 in Latin includes reviewing the root word 22 as the root word 22 is presented in the dictionary. A root word 22 is typically presented in two forms, the nominative singular and the genitive singular. The genitive singular form provides the stem 40 that will be modified by adding an indicia element to give the proper inflection form.

When the root word 22 is presented on the example object 30, such as a textbook, paper, or display device, the stem 40 can be identified by covering a portion of the root word 22 so just the stem 40 remains visible.

The first example card assembly 42 is comprised of a plurality of cards 50 and a connection assembly 52.

The example cards 50 define the card surface 60, the group portion 62, and the rule portion 64. The cards can also include a title portion 220.

The example cards 50 are configured to display text and can be conventional paper, cardstock, plastic or any other material capable of displaying text. The example cards 50 are dimensioned for manual handling, enabling the card assembly 42 to be grasped, carried, and/or manipulate by the average human hand. The size and shape can further facilitate ergonomic use. However, the size of the cards 50 and card assembly 42 is dependent on the plurality of sets of indicia elements 44. The example card assembly 42 includes first 50a, second 50b, third 50c, and fourth 50d cards that are configured to display each declension 80 of the example plurality of sets of indicia elements 44, described in greater detail below.

The example card surface 60 is configured to display text. The example cards 50 define a first card surface 60a and a second card surface 60b. Each card surface 60 is configured to display text in the same or substantially similar manner. Each card surface 60 is configured to distinguish the designated areas as described below.

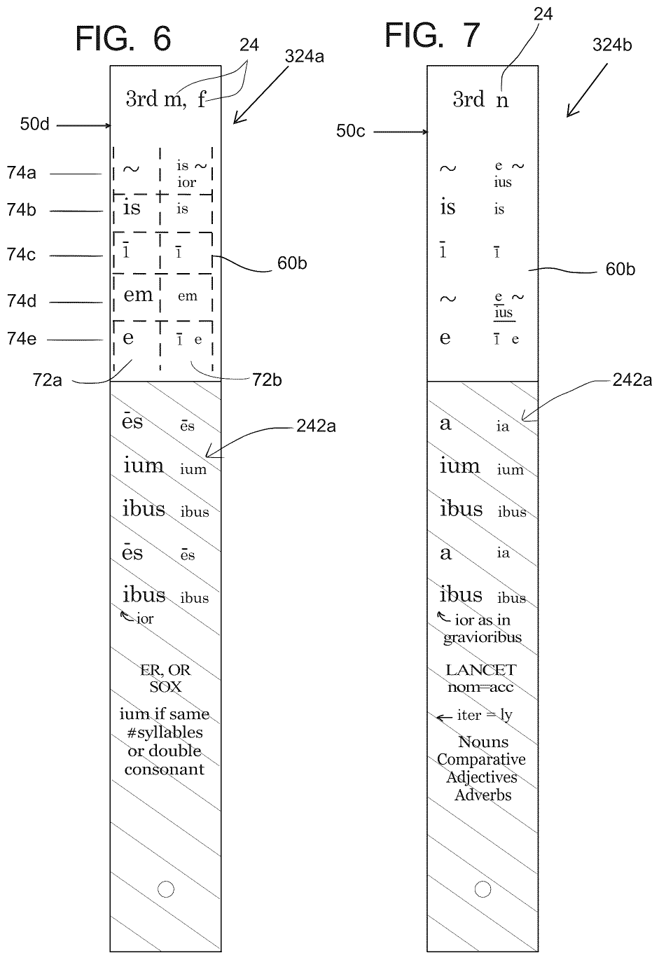

The example group portion 62 is a designated area on the card surface 60 that is configured to display the indicia elements from each set of indicia elements. The example cards 50 define a first group portion 62a and a second group portion 62b. As depicted in FIGS. 3-9, the first group portion 62a is positioned on substantially the top half of the card surface 60 and the second group portion 62b is positioned substantially on the bottom half of the card surface 60. The group portion 62 can be visibly demarcated as a section of the card surface 60 with a given boundary. Each group portion 62a and 62b can be separated by a line 240. Alternatively, the group portions 62a and 62b may be further delineated through shading or coloring 242a or 242b, as depicted in FIG. 6-7 and 8-9. The color or shading 242a or 242b can also be used to designate a different grammatical category 26, as described in more detail below.

The example group portions 62a and 62b further define an array 70 comprised of columns 72 and rows 74. The example array 70 provides an organizational structure, allowing the indicia elements to be spatially arranged within the columns 72 and rows 74 to maintain a particular sequence on each card 50. The example columns 72 represent a vertical sequence of related indicia elements 90, maintaining alignment along a consistent vertical axis. The example rows 74 represent a horizontal sequence and maintain alignment along a consistent horizontal axis. As described in greater detail below, the sequence is or can be the case order 84. The example array 70 includes columns 72 and rows 74 that are not visibly separated with lines; however, in alternative embodiments lines or other shading techniques could illustrate each column or row. As illustrated in FIGS. 5 and 6 by the dotted lines, the array 70 with columns 72 and rows 74 is illustrated.

The example array 70 is a designated portion of the card surface 60 within each group portion 62a and 62b. As depicted, the example cards 130 include a first array 70a and a second array 70b where the first array 70a is arranged in the first group portion 62a and the second array 70b is arranged in the second group portion 62b. However, the example array 70 can vary between cards 30. As illustrated in FIG. 5, the first array 70a and second array 70b are comprised of one column 72 and first 74a, second 74b, third 74c, fourth 74d and fifth 74e rows. However, as illustrated in FIG. 6, the example arrays 70a and 70b include a first 72a and second 72b column, and 72 and first 74a, second 74b, third 74c, fourth 74d and fifth 74e rows.

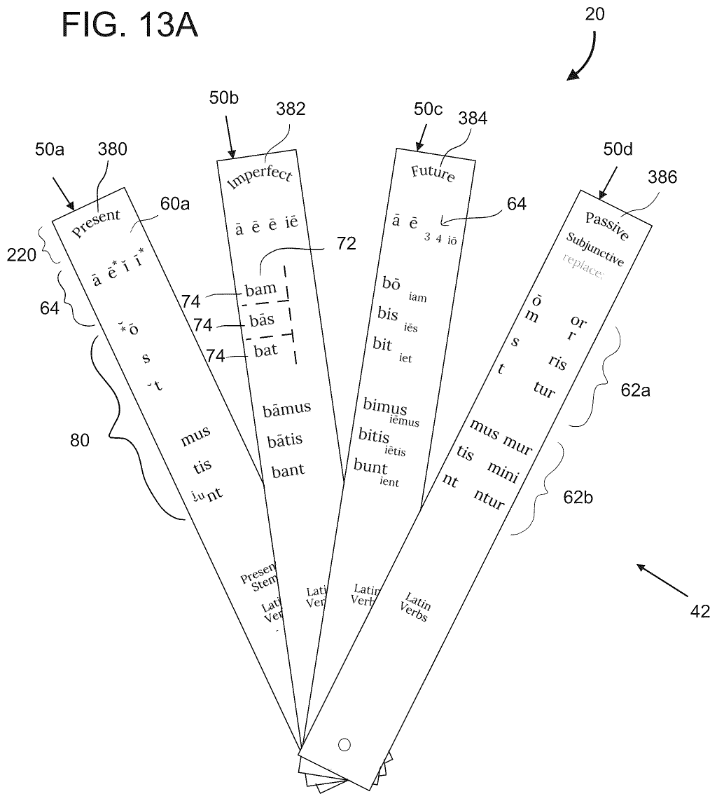

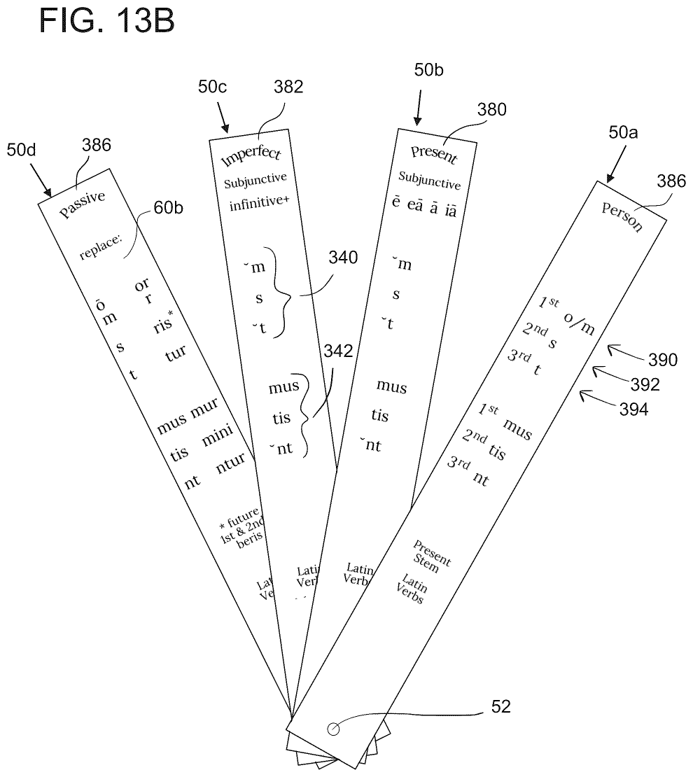

The rule portion 64 is another designated portion of the card surface 60 defined by each card 50. The first example rule portion 64 can positioned below the first group portion 62a and the second group portion 62b. However, as depicted in FIGS. 13A and 13B, the rule portion 62 is positioned above the first group portion 62a and the second group portion 62b. The example rule portion 64 is a portion of the card surface 60 that is configured to depict a variety of rules, as defined by the base language and various grammatical parameters, described in greater detail below.

The example cards 50 can further define the title portion 220. The title portion 220 is a designated area on the card surface 60 that is configured to display text. The example title portion 220 can display the number of the declension 70 and the type 24.

The connection assembly 52 is comprised of a connection opening 250 and a connection member 252.

The connection opening 250 is defined by each card 50. The connection opening 250 provides an opening formed by each card 50 and configured to accommodate the connection member 252. The connection member 252 is positioned at least partially within each connection opening 250 to securely fasten the plurality of cards 50. The connection member 252 can be a rivet or other member that passes though the connection opening 250 ensuring each card 50 remains aligned and held in place while allowing pivoting or rotational movement around the connection member 252.

The rotational movement permitted by the connection member 252 allows the plurality of cards 50 to be reconfigured between an open configuration 260 and a closed configuration 262. In the open configuration 260, the plurality of cards 50 can be expanded so text displayed on each card surface 60 is visible, as illustrated in FIGS. 1A and 1B. In the closed configuration 262, the plurality of cards 50 can be compressed so they overlap with one another such that only one card 50 is visible at a time, as depicted in FIGS. 11A, 11B, and 12.

The example connection assembly 52 is configured at the bottom of each card 50 below the group portions 62a and 62b and the rule portion 64, allowing the text depicted on each card surface 60 to be visible when the cards 50 are rotated or isolated. The connection assembly 52 further allows the plurality of cards 50 to be rotated simultaneously or individually. As illustrated in FIGS. 11a and 11b, when the plurality of cards 130 are connected, an individual card 50a can be isolated, while the other cards 50b, 50c, and 50d are rotated away from the card 50a. The connection assembly 52 is further configured to ensure the plurality of cards 50 and the text depicted on each card surface 60 maintains alignment when connected.

The example plurality of sets of indicia elements 44, as displayed on the card assembly 42 will now be described in further detail.

The example plurality of sets of indicia elements 44 is comprised of the first set of indicia elements 80 defined by the first list type 90, the second set of indicia elements 82 defined by the second list type 92, and the third set of indicia elements 84 defined by the third list type 94 and defining a list order 86.

The first list type 90, second list type 92, and third list type 84 are defined by the case system associated with the base language. The plurality of sets of indicia elements 44 can also include the rule 88.

The plurality of sets of indicia elements 44 is comprised of indicia elements that convey grammatical information based on several parameters. Each indicia element reflects the word ending that will be added to stem 40 so the root word 22 is modified to its selected form 28. Each indicia element is comprised of a collection of letters or symbols defined by the base language that communicate an inflection form for the root word 22.

The example first set of indicia elements 80 is defined by the first list type 90. The example first list type 90 is defined by the declensions of the case system. Declensions are groups of word endings related to each other that can be used to modify a root word 22 based on the type 24 of root word 22 and the grammatical category 26 of the root word 22. Thus, the example first list type 90 organizes the first set of indicia elements 80 such that each first set of indicia elements 80 represents a declension defined by the base language.

The example first set of indicia elements 90 includes a first 320, second 322, third 324, fourth 326, and fifth 328 declension. The following is a general description of use of each declension as related to the root word 22 defined by the Latin language, however, different variations of the declensions 80 are available based on the rules of the base language.

The first declension 320 may be used for root words 22 that are feminine and for root words 22 that are nouns, pronouns, or adjectives. The second declension 322 may be used for root words 22 that are masculine, or neuter and for root words 22 that are nouns, pronouns, or adjectives. The third declension 324 can be used for root words 22 that are masculine, feminine, or neuter, and for root words that are nouns, pronouns and adjectives. The fourth declension 326 can be used for root words 22 that are masculine and only root words 22 that are nouns. The fifth declension 328 can be used for root words 22 that are feminine and only root words 22 that are nouns.

The example second set of indicia elements 82 is defined by the second list type 92. The second list type 92 is defined by the plural groups of the case systems. The plural group refers to whether the root word 22 is in its singular or plural form. Thus, the second list type 92 defines the group of indicia elements that can be used to modify a root word 22 in the singular or in the plural form.

The example second set of indicia elements 84 includes a first number group 340 and a second number group 342. The first number group 340 indicates the singular form, and the second number group 342 indicates the plural form.

The example third set of indicia elements 84 defining a list order 86, is defined by the third list type 94. The third list type 94 is defined by the cases included in the case system. The case refers to the particular function or case a root word 22 will have based on various factors including the sentence context.

Each case is associated with a specific role the root word 22 has, such as the subject, object, or possession. Depending on case, the inflection form of the root word 22 can change. Thus, each case defines an individual indicia element corresponding to the function of the root word 22 in a sentence and that indicia element can be added to the stem 40 to illustrate the proper inflection form.

The example third set of indicia elements 84 includes a first 350, second 352, third 354, fourth 356, and fifth case 358 to reflect the cases as defined by the Latin language. The cases as defined by the Latin language are the nominative, genitive, dative, accusative, and ablative case. The nominative case is when the root word 22 is the subject of the sentence. The genitive case indicates that the root word 22 has possession or ownership in the sentence. The dative case indicates the root word 22 is the indirect object in the sentence. The accusative case indicates that the root word 22 is the direct object of the sentence. The ablative case indicates the root word 22 is used to express the means, manner, or how in a sentence.

The first case 350 represents the nominative case, the second case 352 represents the genitive case, the third case 354 represents the dative case, the fourth case 356 represents the accusative case, and the fifth case 358 represents the ablative case.

The third set of indicia elements 84 define the list order 86. The list order 86 is the order the third set of indicia elements 84 as displayed on each card 50, which starts at the top with the first case 340 and descends in order to the fifth case 348. The list order 86 defines the order of the third set of indicia elements 84 as displayed within the array 70. The list order 86 is depicted consistently on each card 50 of the card assembly 42.

The example plurality of sets of indicia elements 44 can further include a rule 88. The rule 88 describes various grammatical parameters that indicate when an indicia element needs to be used, modified, or exchanged. The rules 88 are defined by the base language and can also indicate what the selected indicia element 40 is for the root word 22.

As described, the plurality of sets of indicia elements 44 are organized and related based on the first list type 92, or declensions, the second list type 92 or plural groups, and the third list type 94, or cases. The declensions include the first set of indicia elements 80 that are related based on the type 24 and category 26 of the root word 22. The number group reflects the second set of indicia elements 92 that should be used depending on if the root word 22 is in its singular form or its plural form. The cases define the third set of indicia elements 84 as it relates to the function or use of the root word 22. Finally, the rule 88 provides further parameters that indicates if an indicia element 90 needs to be used, changed, or modified.

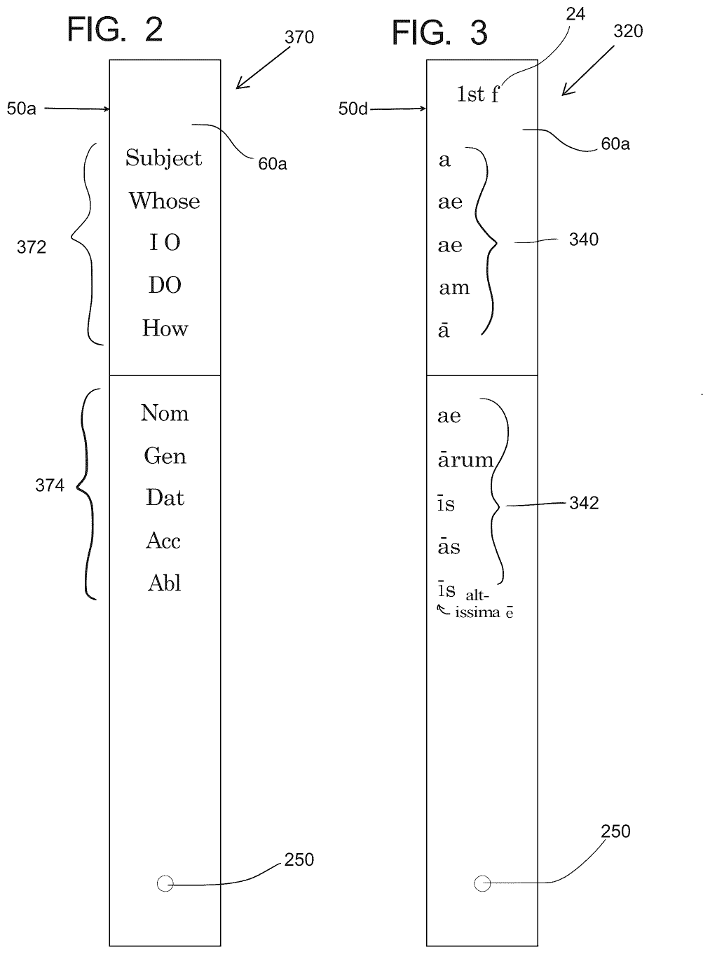

Referring to FIGS. 2-9, the card assembly 42 displaying the plurality of sets of indicia elements 44 will now be described in greater detail.

As illustrated in FIG. 2, a definition card 370 is included in the example card assembly 42. The definition card 370 is optional but can be included to provide definitions or explanations of the first 90, second 92, or third 94 list type. The example definition card 370 includes the names and definition for the second list type 92, referring to each case. The definition card 370 provides a visual association between each case and corresponding indicia element.

The definition card 370 displays a first list 372 and a second list 374. The first list 372 is depicted and arranged in the first group portion 62a on the card surface 60. The second list 374 is depicted and arranged in the second group portion 62b. The first list 372 is a list of words and/or abbreviations of the definitions of each case 350, 352, 354, 356, 358 and is displayed in the list order 86. The second list 234 is the formal name for each case 350, 352, 354, 356, 358 and is displayed in the list order 86. The definition of each case 350, 352, 354, 356, 358 and the formal name for each case 350, 352, 354, 356, 358 is included to associate the formal case names with the third set of indicia elements 84 as displayed in each row 74.

As illustrated in FIG. 3-8 the plurality of sets of indicia elements 44 is displayed on the card assembly 42. While the example card assembly 42 depicts the plurality of sets of indicia elements 44 in the following order, the specific card assembly 42 and/or plurality of sets of indicia elements 44 can be depicted or arranged in various way.

The cards 50 are configured to depict each first set of indicia elements 80, more specifically each declension 320, 322, 324, 326, and 328. The first set of indicia elements 80 can be represented on one or more than one card 50. The first card surface 60a and second card surface 60b are both configured to display at least a portion of the declensions 320, 322, 324, 326, and 328.

On each card surface 60, the title of each declension 320, 322, 324, 326, and 328 can be displayed in the title portion 220 of the card 50. The type 24 of root word can also be represented in the title portion 220 with a letter. The type 24 can be represented feminine “f”, masculine “m”, and neuter “n.” In alternative embodiments, the category 26 can also be represented in the title portion 220.

As previously described, each card 50 defines a first group potion 62a and a second group portion 62b configured to display the first number group 340 and second number group 342 of each declension 320, 322, 324, 326, and 328. The first group portion 62a displays the second set of indicia elements 82 that can be used when the root word 22 is in its singular form. The second group portion 62b depicts the second set of indicia element 82 that can be used when the root word 22 is in its plural form.

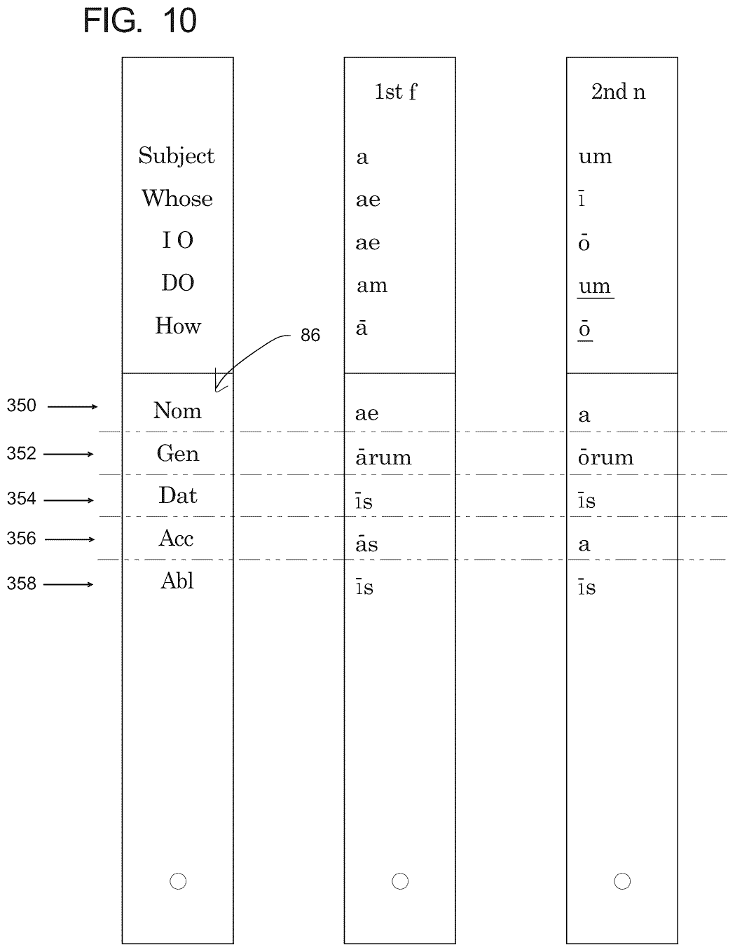

Within each group portion 62a and 62b, the example array 70 comprising at least one column 72 and five rows 74a, 74b, 74c, 74d, and 74e. Each row 74 is configured to display each indicia element from the third set of indicia elements 84. The indicia elements are displayed in each column 72 according to the list order 86. Thus, the first row 74a corresponds to the first case 350, the second row 74b corresponds to the second case 352, the third row 74c corresponds to the third case 354, the fourth row 74d corresponds to the fourth case 356, and the fifth row 74e corresponds to the fifth case 358. As illustrated in FIG. 10, the dashed lines indicate the separate rows 74 and indicia elements arranged in the list order 86.

The rule portion 64 is configured to depict the rule 88. The rule 88 can take a variety of forms, thus the rule portion 64 provides enough space to accommodate the rules 88. The rule portion 88 can also depict the category 24 of root word 22.

The example card assembly 42, utilizes both card surfaces 60a and 60b to depict the plurality of sets of indicia elements 44 so that each first set of indicia elements 80, or at least a portion of each first set of indicia elements 80 is illustrated on one of the plurality of cards 50a, 50b, 50c, 50d. As preferred, the declensions 320, 322, 324, 326, and 328 are organized in order, as illustrated in FIGS. 1a and 1b.

More specifically, the first declension 320 is depicted in FIG. 3. The first declension 320 is depicted on the first card surface 60a of the fourth card 130d. The first declension 320 includes the title of the declension 320 “1^{st}” and the type 24 “f” in the title portion 220. The first group portion 62a depicts the five indicia elements 84a, 84b, 84c, 84d, and 84e from the third set of indicia elements 84 that are associated with the first number group 340. The second group portion 62b depicts the five indicia elements 84a, 84b, 84c, 84d, and 84e from the third set of indicia elements 84 that are associated with the second number group 342.

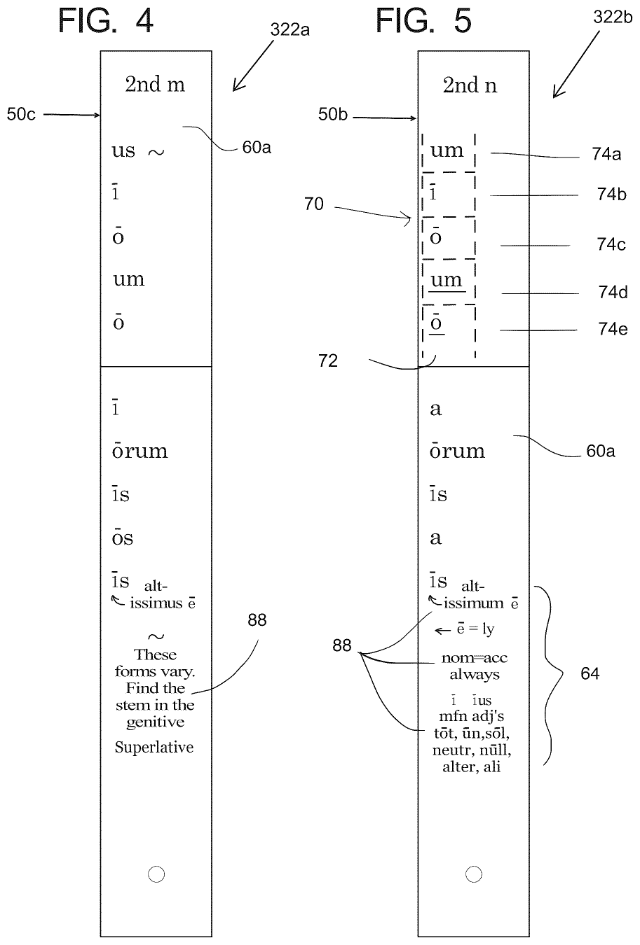

FIGS. 4 and 5 illustrate the second declension 322 is depicted on the third card 50c and second card 50b. The second declension 322a is depicted on the first card surface 60a of the third card 50c. The second declension 322b is depicted on the first card surface 60a of the second card 50b. The second declension 322a includes a rule 88a depicted in the rule portion 64 of the third card 50c. The second declension 322b also includes a rule 88b depicted in the rule portion 64 of the second card 50b.

FIGS. 6 and 7 illustrate the third declension 324 on the fourth card 50d and third card 50c. The third declension 324a is depicted on the second card surface 62b of the fourth card 50d. The third declension 324b is also depicted on the second card surface 62b of the third card 50c. The third declension 324a includes the type 24 masculine “m” and neuter “n” in the title portion 220 of the fourth card 50d. Within each group portion 62a and 62b of the third declension 324a, the array 70 includes two columns 72a and 72b. Within each column 72a and 72b, the third set of indicia elements 84 are still arranged in each row 72a, 72b, 72c, 72d and 72e according to the list order 86. The third declension 324b also includes an array 70 having two columns 72a and 72b configured to display the third set of indicia elements 84. The third declension 324a and 324b also includes rules 88a and 88b, arranged in the rule portion 64 of each card 130d and 130c.

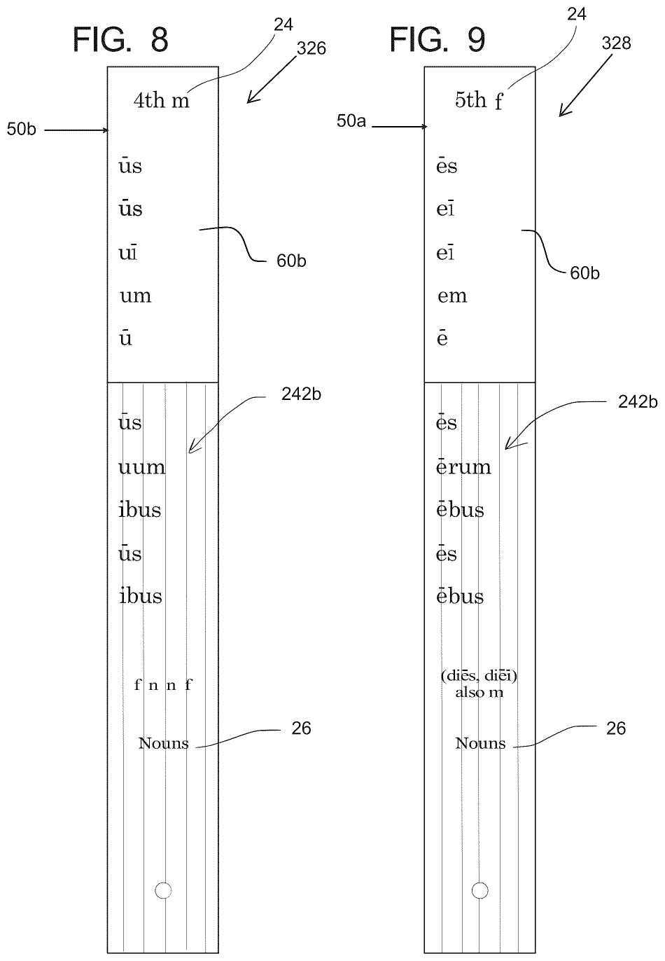

FIG. 8 illustrates the fourth declension 326. The fourth declension is depicted on the second card surface 140b of the second card 130b. The fourth declension 326 includes the category 26 in the rule portion 64. As depicted the category “Nouns” is reflected to indicate the fourth declension 326 can only be used for root words 22 that fall into the category 26 of nouns.

FIG. 9 illustrates the fifth declension 328. The fifth declension 328a is depicted on the second card surface 140b of the first card 130a. As depicted the category “Nouns” is reflected to indicate the fifth declension 328 can only be used for root words 22 that fall into the category 26 of nouns.

Referring to FIGS. 13A and 13B, the card assembly 40 displaying a plurality of sets of indicia elements 44 that can be used when the root word 22 is a verb is depicted. For root words 22 that are classified as verbs, the plurality of sets of indicia elements 44 are defined by different list types. More specifically, the first list type 90 is defined by the tense of each verb or the voice of the verb: present tense 380, imperfect tense 382, future tense 384, passive/active voice 386, or person (speaker) voice 388. The second list type 92 is defined by whether the verb is for a singular or plural noun and including a first number group 340 and a second number group 342, as described above. The third list type 94 is defined by the subject the verb. The third list type 94 defines first person 390, second person 392, and third party 394 which also defines the list order 86. The first person 392 means the speaker is the subject of the verb, the second person 392 means the listener is the subject of the verb, and the third person 394 means a third party is the subject of the verb. A definition card (not pictured) can be included to define the third list type 394. Further, the rule portion 64 is included above the first group portion 62a and the second group portion 62b. The rule portion 64 includes at least one rule 88 defined by the base language for root words 22 that are verbs.

As an additional feature of the language adapter 20, the card assembly 42 displaying the plurality of sets of indicia elements 44 according to the foregoing arrangement allows each first set of indicia elements 90 to be compared to the others easily. The visual representation in which each set is aligned with others allows the differences between each declension to be learned or taught faster.

Given the foregoing understanding of the construction and operation of the example card assembly 42, the details of the operation and use of the language adapter 20 will now be described in further detail.

The language adapter 20 is or can be used when modifying a root word 22 to a selected form 28. The stem 40 is determined based on the root word 22. The stem and/or the root word 22 can be presented audibly or used in conjunction with a textbook or other background object 30 that depicts the stem 40 and/or root word 22. In order to modify the root word 22, the selected indicia element 46 reflecting the correct inflection form must be identified. The selected indicia element 46 will be identified by selecting one of the sets of indicia elements from the first set of indicia elements 80, the second set of indicia elements 82, and the third set of indicia elements 84.

The selected indicia element 46 indicates the proper inflection form that needs to be added to the stem 40 of the root word 22 to modify the root word 22 to the selected form 28. The selected indicia element 46 will be determined based on the type 24 and category 26 of the root word 22, the first list type 90, the second list type 92, and the third list type 94.

The type 24 and category 26 of the root word 22 determines which first set of indicia elements 80, or declension 320, 322, 324, 326, or 328, includes the selected indicia element 46. As an example, if the type 24 of the root word 22 is feminine and the category 26 is a noun 50, the fifth declension 328 would be the first set of indicia elements 80 that includes the selected indicia element 46. Once the declension is identified, the card assembly 42 can be manipulated to the closed configuration 262 so the card 50 displaying the selected declension is isolated.

The first set of indicia elements 80 includes a plurality of indicia elements that can be used to modify the root word 22. However, the selected form 28 specifically identifies which indicia element is the selected indicia element 46.

The selected form 28 defines whether the root word 22 is going to be used in its singular form or its plural form. The selected form 28 also indicates the case 82 of the root word 22 based on its context.

The second list type 92 includes the second set of indicia elements 82 that can be used depending on whether the root word is used in its singular or plural form. If the root word 22 is used in its singular form, then the selected indicia element 46 will be chosen from the first number group 340. Likewise, if the root word 22 is used in its plural form, then the selected indicia element 46 will be chosen from the second number group 342.

Once the second set of indicia elements 82 is identified, then the third list type 94 will determine which indicia element from the third set of indicia elements 84 is the selected indicia element 46.

As an example of identifying the selected indicia element, if the fifth declension 328 is the correct declension based on the root word 22, then the selected indicia element 46 is one of the plurality indicia elements included in the fifth declension 328. If the root word 22 needs to be modified to its plural form, then the second number group 342 includes the selected indicia element 46.

Then, if the function of the root word 22 is as the first case 350, or subject of the sentence, then the selected indicia element 46 is the indicia element 90a defined by the first case 340 which is “ĕs”, as depicted in FIG. 9.

Once the selected indicia element 46 is identified, the card 50 displaying the first set of indicia elements 80 that includes the selected indicia element 46 can be manipulated to align the selected indicia element 46 with the stem 40 of the root word 22, if the stem 40 is depicted on a background object 30. If the root word 22 or stem 40 is not depicted on a background object 30, then the card assembly 42 can still be manipulated to isolate the card 50 displaying the selected indicia element 46. The stem 40 can then be conceptually or verbally aligned with the selected indicia element 46 to successfully modify the root word 22 to its selected form 28.

As depicted by FIGS. 11A, 11B, and 12, if the selected indicia element 46 was not correctly identified, the card assembly 42 can be easily manipulated to isolate a different card 50 displaying a different first set of indicia elements 80. Alternatively, if first set of indicia elements 80 is properly identified based on the root word 22, however the selected indicia element 46 is not, the card 50 displaying the first set of indicia elements 80 can be slid upward or downward to navigate to align a second selected indicia element 120 which properly modifies the root word 22 to the selected form 28, as indicated by arrow 130 in FIG. 11A.

### II. Second Example Language Adapter

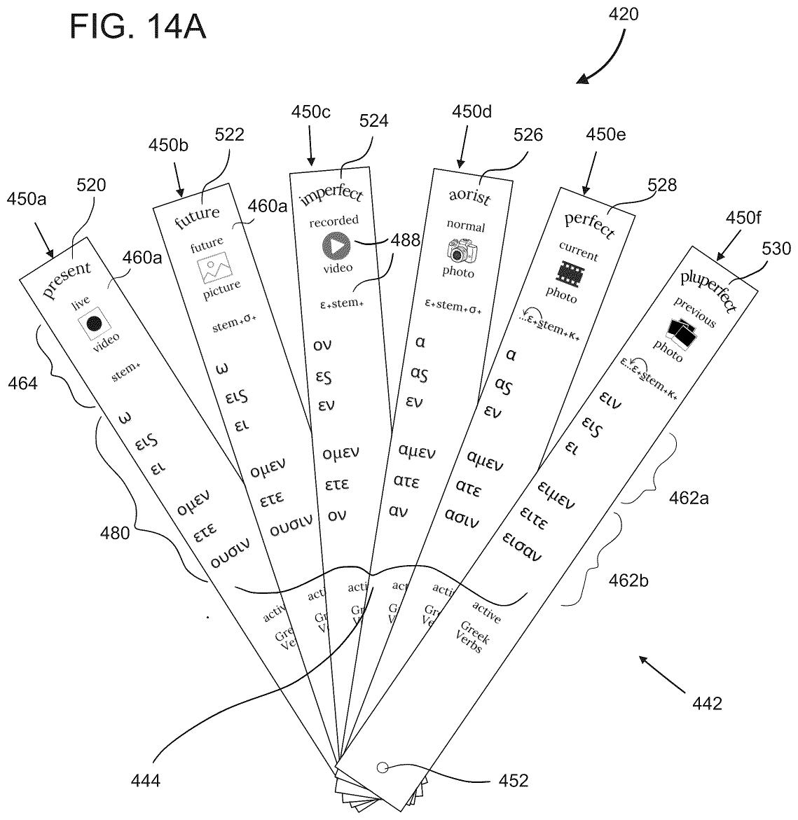

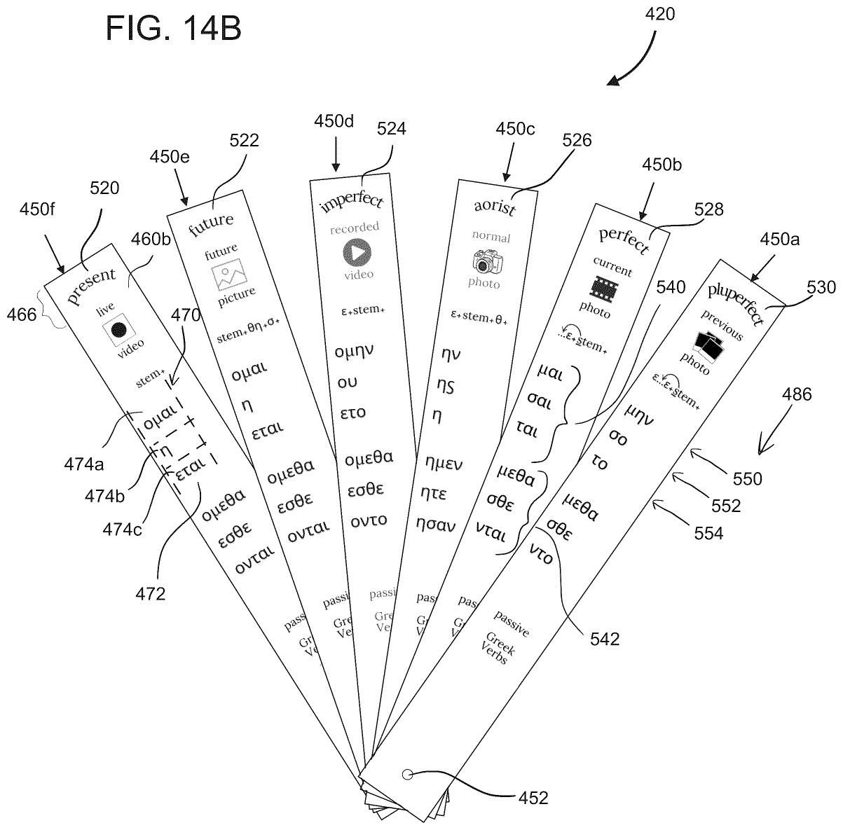

As shown in FIGS. 14A and 14B, a second example language adapter 420 can be used to indicate the correct modification for a root word 22 that is classified by a type 24 and grammatical category 26 to a selected form 28 where the selected form 28 is defined by a base language, more specifically a Greek Language. The second example language adapter 420 operates in the same or substantially similar manner to the first example language adapter 420.

The second example language adapter 420 is comprised of a stem 440 (not pictured), a card assembly 442, a plurality of sets of indicia elements 444, and a selected indicia element 446.

The second example card assembly 442 is comprised of a plurality of cards 450 and a connection assembly 452. The example cards 450 define a card surface 460, a group portion 462, and rule portion 464. The cards can also include a title portion 466. The second example language adapter 420 basically operates substantially similar to the first example language adapter 20 however, the plurality of sets of indicia elements 444 are defined by the base language in Greek. Further the arrangement of the second example plurality of sets of indicia elements 444 on the card assembly 442 are varied.

The second example plurality of sets of indicia elements 444 is comprised of the first set of indicia elements 480 defined by the first list type 490, the second set of indicia elements 482 defined by the second list type 492, and the third set of indicia elements 484 defined by the third list type 494 and defining a list order 486. The first list type 490, second list type 492, and third list type 484 are defined by the case system associated with Greek. The plurality of sets of indicia elements 444 can also include a rule 488.

More specifically, the first list type 480 is defined by the tenses of the case system associated with the base language. The second list type 482 is defined by the plurality of the root word 22, whether it is singular or plural. The third list type is defined by the subject or person of a verb of the case system associated with the base language. Thus, the display of the plurality of sets of indicia elements 444 is as follows.

The second example first list type 490 defines at least six tenses: present 520, future 522, imperfect 524, aorist 526, perfect 528 and pluperfect 530. The second example first set of indicia elements 480 is defined by first list type 490. Thus, the first list type 490 organizes the first set of indicia elements 480 based on the tense of the root word 22.

The second example second list type 492 is defined by the plural group of the case system. The second example second set of indicia elements 482 is defined by the second list type 492 into a first group 540 and a second group 542. Thus, the second list type 492 defines the group of indicia elements that can be used to modify a root word 22 in the singular or in the plural form.

The third example list type 494 is defined by the subject of the verb and defines at least three subjects: first person 550, second person 552, and third person 554. The second example third set of indicia elements 484 defining a list order 486, is defined by the third list type 494. Thus, the third example third list type 494 organizes the third set of indicia elements 484 such that each indicia element corresponds to the subject of the verb, or root word 22.

Alternatively, for root words 22 that are nouns or adjectives, the plurality of sets of indicia elements 444 can be defined by different list types and displayed on the card assembly 444 respectively. More specifically, the first list type 490 can be defined by the cases of the case system: nominative, genitive, dative, accusative. The second list type 492 can be defined by whether the verb is for a singular or plural noun and defining the first number group 540 and a second number group 542, as described above. The third list type 494 can be defined by the declensions of the case system. The third set of indicia elements 484 also defines the list order 486, as described above.

The example plurality of sets of indicia elements 444 can further include a rule 488. The rule 488 describe various grammatical parameters that indicate when an indicia element needs to be used, modified, or exchanged. The rules 488 are defined by the base language and can also indicate what the selected indicia element 446 is for the root word 22.

Referring to FIG. 13, the second example language adapter 420 is depicted.

The cards 450 are configured to depict each first set of indicia elements 480, more specifically each tense: present 520, future 522, imperfect 524, aorist 526, perfect 528 and pluperfect 530. On each card surface 460, the title of each tense 520, 522, 524, 526, 528 and 530 can be displayed in the title portion 466 of the Card 450.

As previously described, each card 450 defines a first group potion 462a and a second group portion 462b configured to display the first number group 540 and second number group 542 of each tense: present 520, future 522, imperfect 524, aorist 526, perfect 528 and pluperfect 530. The first group portion 462a displays the second set of indicia elements 482 that can be used when the root word 22 is in its singular form, or the first number group 540. The second group portion 462b depicts the second set of indicia element 482 that can be used when the root word 22 is in its plural form, or the second number group 542.

Within each group portion 462a and 462b, the example array 470 comprising at least one column 472 and three rows 474a, 474b, and 474c. Each row 474 is configured to display each indicia element from the third set of indicia elements 484. The indicia elements are displayed in each column 472 according to the list order 486. Thus, the first row 474a corresponds to the first person 550, the second row 474b corresponds to the second person 552, and the third row 474c corresponds to the third person 554.

The rule portion 464 is configured to depict the rule 488. The rule 488 can take a variety of forms, thus the rule portion 464 provides enough space to accommodate the rules 488.

The example card assembly 442, utilizes both the card surfaces 460 to depict the plurality of sets of indicia elements 444 so that each first set of indicia elements 480, or at least a portion of each first set of indicia elements 480 is illustrated on one of the plurality of cards 450a, 450b, 450c, 450d. As preferred, the tenses 520, 522, 524, 526, and 528 are organized in order, as illustrated in FIGS. 14A and 14B.

Further, the second example a card assembly 442 is illustrated comprising six cards 450a, 450b, 450c, 450d, 450e, and 450f to depict six cases defined by the Greek language, however, the second example language adapter 420 is configured to include more cards, cases, or declensions as defined by the Greek language. For example, the Greek language defines at least fifteen declensions.

### III. Third Example Langauage Adapter—German

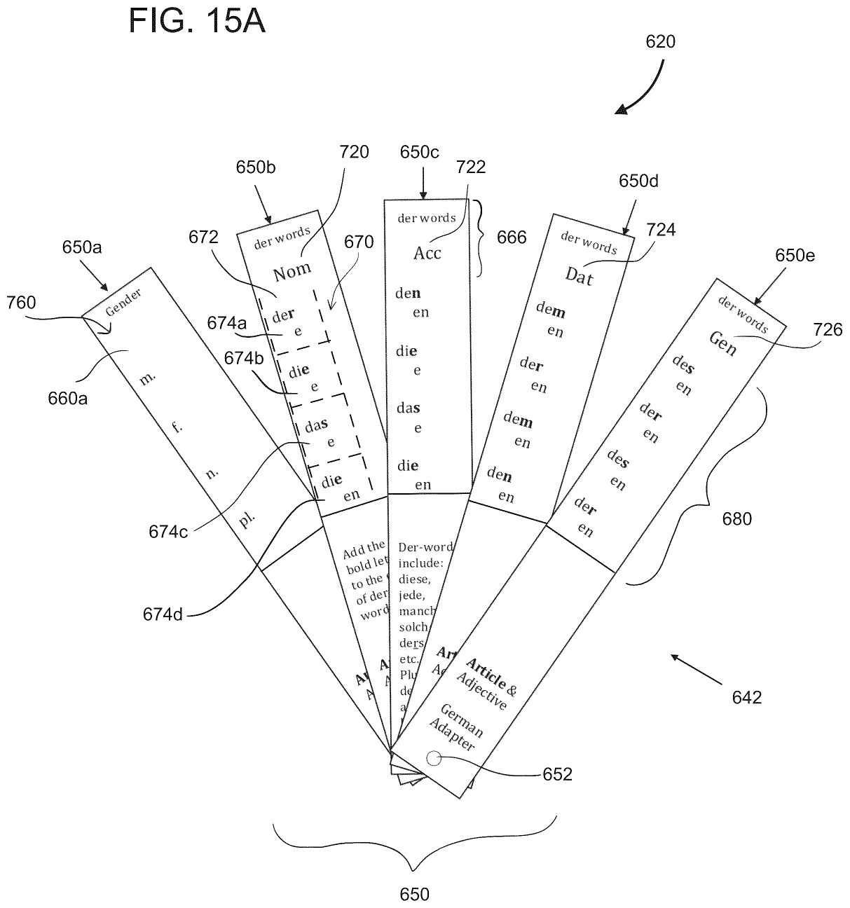

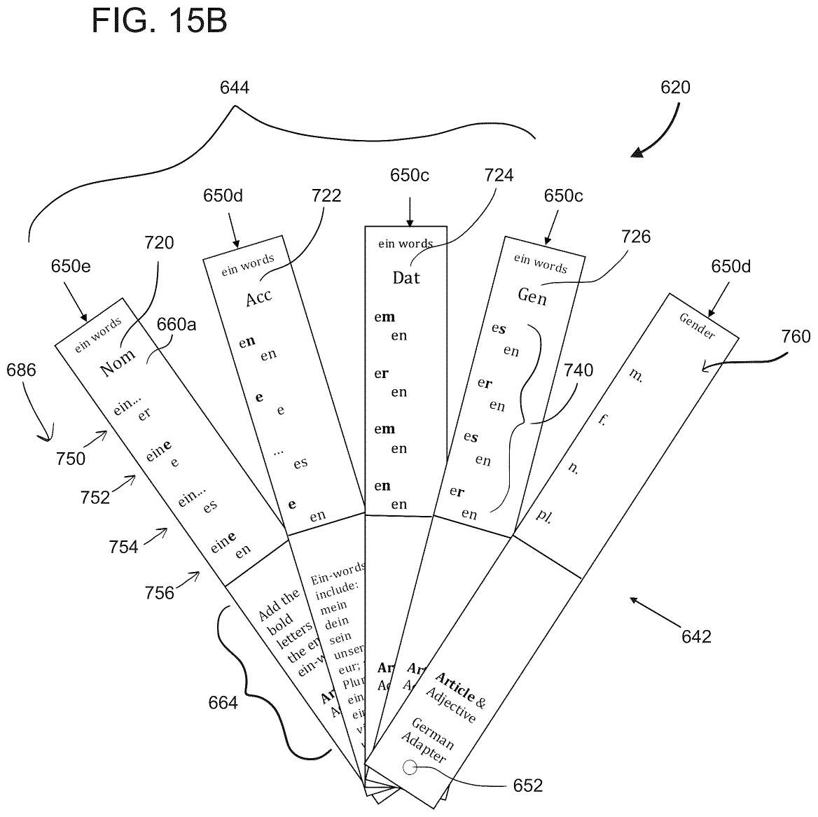

As shown in FIGS. 15A and 15B, a third example language adapter 620 can be used to indicate the correct modification for a root word 22 that is classified by a type 24 and grammatical category 26 to a selected form 28 where the selected form 28 is defined by a base language, more specifically the German language. The third example card assembly 642 operates in the same or substantially similar manner to the second example card assembly 442 and the first example card assembly 42. The root word 22 for the third example language adapter 620 can be an article, adjective, verb, or noun.

The third example language adapter 620 is comprised of a stem 640, a card assembly 642, a plurality of sets of indicia elements 644, and a selected indicia element 646.

The third example stem 640 is or can be an article as defined by the base language. Depending on the root word 22, the article will also need to be modified using the language adapter 620.

A third example card assembly 642 is comprised of a plurality of cards 650 and a connection assembly 652. The example cards 650 define a card surface 660, a group portion 662, and a rule portion 664. The cards 650 can also include a title portion 666. The third example language adapter 620 operates substantially similar to the first example language adapter 20 and second example language adapter 420 however, the plurality of sets of indicia elements 644 are defined by the base language in German. Further the arrangement of the third example plurality of sets of lists 644 on the card assembly 642 are varied.

The third example plurality of sets of indicia elements 644 is comprised of the first set of indicia elements 680 defined by the first list type 690, the second set of indicia elements 682 defined by the second list type 692, and the third set of indicia elements 684 defined by the third list type 694 and defining a list order 686. The first list type 690, second list type 692, and third list type 684 are defined by the case system associated with German. The plurality of sets of indicia elements 644 can also include a rule 688.

More specifically, the first list type 680 is defined by the cases of the case system associated with the base language. The second list type is defined by the type 24 of the root word and whether the root word 22 is an article or adjective. The third list type 684 is defined by the gender of the case system associated with the base language. Thus, the display of the plurality of sets of indicia elements 644 is as follows.

The third example first list type 690 defines at least four cases 720 (nominative), 722 (accusative), 724 (dative), and 726 (genitive). The third example first set of indicia elements 680 is defined by first list type 690. Thus, the first list type 690 organizes the first set of indicia elements 680 based on the function of the root word 22 in a sentence.

The third example second list type 692 is defined by the type 24 of the stem 640 and root word 24. The third example second set of indicia elements 680 is defined by the second list type 692 into a first group 740. Thus, the second list type 692 defines the group of indicia elements that can be used to modify a stem 640 that is an article and root word 22 that is a noun or adjective.

The third example third list type is defined by the gender or number of the case system. The third set of indicia elements 684 defining a list order 486, is defined by the third list type 694. Thus, the third example third list type 694 organizes the third set of indicia elements 684 such that each third set of indicia elements 694 corresponds to a gender or plural grouping defined by the base language.

In the third example third set of indicia elements, defines four third sets of indicia elements, or genders or plural group, 750 (masculine), 752 (feminine), 754 (neuter), and 756 (plural). The list order 684 follows the order the third set of indicia elements 684 and is displayed on each card 650, which starts at the first gender 684a and descends in order to the plural group 684e.

The third example plurality of sets of indicia elements 644 can further include a rule 688. The rule 688 describe various grammatical parameters that indicate when an indicia element needs to be used, modified, or exchanged. The rules 688 are defined by the base language and can also indicate what the selected indicia element 646 is for the stem 640 and root word 22.

Referring to FIG. 15a and 15b, the third example language adapter 620 is depicted.

The third example cards 650 are configured to depict each first set of indicia elements 680, more specifically each case 720, 722, 724, and 726. The third example cards 650 also include a definition card 760. On each card surface 660, the title of each case 720, 722, 724, and 726 can be displayed in the title portion 666 of the card 650. The stem 640 or root word 24 can also be represented in the title portion 666.

As previously described, each card 650 defines at least one group potion 662 configured to display the first group 740 of each case 720, 722, 724, and 726. The group portion 662 displays the second set of indicia elements 682 that can be used when the stem 640 or root word 22 is either an article or adjective. In similar configurations, the 640 or root word 22 can be a verb or noun.

Within the group portion 662, the example array 670 comprising at least one column 672 and four rows 674a, 674b, 674c, and 674d. Each row 674 is configured to display at least one indicia element from the third set of indicia elements 684. The indicia elements are displayed in each column 672 according to the list order 686. Thus, the first row 674a corresponds to the masculine gender 750, the second row 674b corresponds to the feminine gender 752, the third row 674c corresponds to the neuter gender 754, and the fourth row 674d corresponds to the plural group 756.

The rule portion 664 is configured to depict the rule 688. The rule 688 can take a variety of forms, thus the rule portion 664 provides enough space to accommodate the rules 688. The rule portion 688 can also depict the category 24 of root word 22.

The example card assembly 642, utilizes the card surface 660 to depict the plurality of sets of indicia elements 644 so that each first set of indicia elements 680, or at least a portion of each first set of indicia elements 680 is illustrated on one of the plurality of cards 650a, 650b, 650c, 650d, and 650e. As preferred, the cases 720, 722, 724, and 726 are organized in order, as illustrated in FIGS. 15A and 15B.

Further, the third example a card assembly 642 is illustrated comprising five cards 650a, 650b, 650c, 650d, and 650e to depict five cases defined by the Germain language, however, the third example language adapter 620 is configured to include more cards, cases, declensions, gender groups, or articles as defined by the German language.

What is claimed is:

1. A language adapter for modifying a root word classified by a type and a grammatical category to a selected form defined by a base language, the language adapter comprising:
a stem defined by the root word;
a card assembly comprising
a plurality of cards configured to display text, the plurality of cards defining
at least one card surface,
at least one group portion further defining at least one array wherein the array is comprised of at least one column and the at least one column is comprised of a plurality of rows,
a connection assembly configured to rotatably connect the plurality of cards;
a plurality of sets of indicia elements, where each set of indicia is defined by a case system associated with the base language comprising
a first set of indicia elements defined by a first list type,
a second set of indicia elements defined by a second list type,
a third set of indicia elements defined by a third list type, where the third set of indicia elements defines a list order,
a selected indicia element chosen from the plurality of sets of indicia elements determined based on the root word, the first list type, the second list type, and the third list type; wherein
the card assembly is configured to display the plurality of sets of indicia elements such that
the first set of indicia elements is displayed on the at least one card surface,
the second set of indicia elements is displayed in the at least one group portion,
the third set of indicia elements are arranged in the array in the list order such that each row depicts at least one indicia element; and
the card assembly can be manipulated so the card displaying the selected indicia element can be aligned with the stem to modify the root word.

2. The language adapter of claim 1, further comprising at least one rule and in which the plurality of cards further defines at least one rule portion and the at least one rule is displayed in the at least one rule portion.

3. The language adapter of claim 2, in which the rule defines the selected indicia element.

4. The language adapter of claim 1, in which the selected indica element can be exchanged with a second selected indicia element chosen from the plurality of sets of indicia elements and based on the selected form.

5. The language adapter of claim 1, in which the second list type defines at least two second sets of indicia elements.

6. The language adapter of claim 1, in which each card has a first card surface and a second card surface.

7. The language adapter of claim 6, in which the plurality of sets of indicia elements are displayed on the first card surface and the second card surface.

8. A language adapter for modifying a root word classified by a type and a grammatical category to a selected form defined by a base language, the language adapter comprising:
a stem defined by the root word, where the stem is displayed on a background object;
a card assembly comprising
a plurality of cards configured to display text, the plurality of cards defining
at least one card surface,
at least one group portion further defining at least one array wherein the array is comprised of at least one column and the at least one column is comprised of a plurality of rows,
a connection assembly configured to rotatably connect the plurality of cards;
a plurality of sets of indicia elements, where each set of indicia is defined by a case system associated with the base language comprising
a first set of indicia elements defined by a first list type,
a second set of indicia elements defined by a second list type,
a third set of indicia elements defined by a third list type, where the third set of indicia elements defines a list order,
a selected indicia element chosen from the plurality of sets of indicia elements determined based on the root word, the selected form, the first list type, the second list type, and the third list type; wherein
the card assembly is configured to display the plurality of sets of indicia elements such that
the first set of indicia elements is displayed on the at least one card surface,
the second set of indicia elements is displayed in the at least one group portion,
the third set of indicia elements are arranged in the array in the list order such that each row depicts at least one indicia element; and
the card assembly can be manipulated so the card displaying the selected indicia element can be aligned with the stem on the background object to modify the root word to the selected form.

9. The language adapter of claim 1, further comprising at least one rule and in which the plurality of cards further defines at least one rule portion and the at least one rule is displayed in the at least one rule portion.

10. The language adapter of claim 2, in which the rule defines the selected indicia element.

11. The language adapter of claim 1, in which the selected indica element can be exchanged with a second selected indicia element chosen from the plurality of sets of indicia elements and based on the selected form.

12. The language adapter of claim 1, in which the second list type defines at least two second sets of indicia elements.

13. The language adapter of claim 1, in which each card has a first card surface and a second card surface.

14. The language adapter of claim 6, in which the plurality of sets of indicia elements are displayed on the first card surface and the second card surface.

15. A method for modifying a root word of a specific type and grammatical category to a selected form, comprising the steps of
determining a stem from the root word;
providing a plurality of cards configured to display text, each card defining
at least one card surface
at least one group portion further defining at least one array wherein the array is comprised of at least one column and a plurality of rows;
rotatably connecting the plurality of cards with a connection assembly;
providing a plurality of sets of indicia elements defined by a case system associated with the language, where the plurality of sets of indicia elements comprises
a first set of indicia elements defined by a first list type,
a second set of indicia elements defined by a second list type,
a third set of indicia elements defined by a third list type, where the third set of indicia elements defines a list order,
choosing a selected indicia element from the plurality of sets of indicia elements determined based on the root word, the selected form, the first list type, the second list type, and the third list type;
displaying the plurality of sets of indicia elements on the plurality of cards so that
the first set of indicia elements is displayed on the at least one card surface,
the second set of indicia elements is displayed in the at least one group portion,
the third set of indicia elements are arranged in the array in the list order such that each row depicts at least one indicia element; and
aligning the selected indicia element with the stem to modify the root word to the selected form.

16. The method of claim 15, further comprising the step of exchanging the selected indicia element with a second selected indicia element, in which the second selected indicia element is selected from the plurality of indicia elements and based on the selected form of the root word.

17. The method of claim 15, in which the step of providing a plurality of cards comprises the step of defining a rule portion on each card.

18. The method of claim 17, in which the step of providing a plurality of cards comprises the step of displaying a rule in the rule portion.

19. The method of claim 15, in which the step of providing a plurality of cards comprises the step of providing a first card surface and a second card surface.

20. The method of claim 19, further comprising the step of displaying the plurality of sets of indicia elements on the first card surface and the second card surface.
